(19) United States
(12) Patent Application Publication
(10) Pub. No.: US 2015/0321594 A1
(43) Pub. Date: Nov. 12, 2015

(54) Long-Reach Vacuum Extraction

(71) Applicants: Gary Ward Harms, JR., Fort Morgan, CO (US); Jason Thomas White, Brighton, CO (US)

(72) Inventors: Gary Ward Harms, JR., Fort Morgan, CO (US); Jason Thomas White, Brighton, CO (US)

(21) Appl. No.: 14/615,365

(22) Filed: Feb. 5, 2015

Related U.S. Application Data
(60) Provisional application No. 61/991,468, filed on May 10, 2014.

(51) Int. Cl. B60P 1/60; E02F 3/88

(52) U.S. Cl. CPC B60P 1/60; E02F 3/8816

(57) ABSTRACT

A boom, most commonly used in conjunction with a cement truck to deliver cement a great distance from the cement truck to the work site, is adapted to be used with a truck mounted vacuum extraction system. In this instance, the boom is used in a completely backwards fashion. Instead of being connected to a pump, which pumps material to a work site, the boom is connected to the vacuum extraction vacuum blower in order to bring debris at the excavation site to the debris tank of the vacuum extraction system. The boom is able to reach up, over, under, or around barriers that stand in the way. In addition, the boom can also reach through or go under existing structures to reach the excavation site.

### CROSS REFERENCE TO RELATED APPLICATION

This application claims the benefit of U.S. Provisional Application Ser. No. 61/991,468 filed on May 10, 2014 titled “LONG-REACH VACUUM EXTRACTION” which is incorporated herein by reference in its entirety for all that is taught and disclosed therein. This application is also related to U.S. Provisional Application Ser. No. 61/991,471 titled “TRACKED VEHICLE VACUUM EXTRACTION” which was filed on May 10, 2014, and is incorporated by reference for all that is taught and disclosed therein.

### BACKGROUND

Vacuum extraction is a non-mechanical, non-destructive process that uses an industrial strength vacuum to simultaneously excavate and evacuate soil below grade or extract materials above grade. As vacuum extraction safely removes material above grade, or breaks up soil below grade, the material or soil is conveyed by high volume air vacuum through a suction hose to a debris tank. Instead of manual or mechanical digging methods, air pressure breaks up the soil, which virtually eliminates any risk of underground utility damage. The vacuum extraction process results in safe, fast, and precise excavations that require less backfill, labor, and restoration, and has less environmental impact than traditional extraction techniques. Hand dig tools or pneumatically driven dig tools may be used to help gently break up the soil to aid in the process. Similarly, hydro-excavation utilizes hand-held high-pressure wands to help break up the soil. Hydro-excavation trucks may have tanks to carry the fluid needed for the wand, which is typically water, but could be any other suitable fluid. The vacuum system sucks up a slurry of soil and fluid into the debris tank. Both types of extraction are referred to hereinafter as simply vacuum extraction.

Excavating or exposing underground utilities using vacuum extraction is called potholing or daylighting. Since vacuum extraction is a non-mechanical, non-destructive process, it enables underground utilities to be exposed without the risks inherent in traditional manual or mechanical extraction methods. Potholing is also a generally accepted time and cost saving digging method for the installation of signs, telephone poles, fences, and the like.

Digging narrow trenches for installing pipes, cables or other in-ground utilities is called slot trenching. Unlike traditional mechanical slot trenchers, which can cause serious and costly damage to buried infrastructure, vacuum extraction provides a non-destructive and efficient slot trenching method even on frozen surfaces. Vacuum extraction makes it easy and safe to install sprinkler systems, locate underground utilities, and perform similar installations without the risk of damaging previously installed systems or lines.

With vacuum extraction's precise, non-destructive characteristics, it can be used to remove debris and clean out a variety of structures without damaging the surrounding area. Vacuum extraction is also an ideal solution for catch basin cleaning, sludge removal, and cleaning up spills.

With vacuum extraction's precision, it is ideal for pile hole excavation. Underground utilities that may be uncovered during excavation are not harmed in contrast to the high risk of damage that exists with using manual or mechanical digging methods.

Since hydro-excavation trucks are equipped with truck-mounted heaters, cold weather does not deter them from working. Unlike traditional ground thawing methods that use wood or coal, hydro-excavation is environmentally friendly and safe.

When fiber optic cables, telephone lines, water mains, or other utility lines need to be repaired, or excavation needs to be done in tight or congested spaces, vacuum extraction equipment can be located a short distance away from the actual excavation site. This minimizes the impact and restoration requirements to the actual site, and may eliminate traffic congestion and inconvenience.

Safety has become a top concern in recent years, and the importance has been greatly amplified. There has been an increase in fatalities from pipeline explosions. The Transportation Department cites the biggest cause of such accidents as excavations that disturb gas lines. As a result, most big pipeline companies are beginning to mandate safe digging methods such as vacuum extraction. The Pipeline Inspection, Protection, Enforcement, And Safety Act Of 2006 (Public Law 109-468—Dec. 29, 2006), the 811 One-Call regulations, and subsequent enhancements by a few states, have all increased the focus on safe extraction techniques. There are regulations that stipulate that there can be no excavation using power tools within 18″ to 24″ of marked utilities, and if excavators adhere to this requirement, they are not liable for any damages to underground utilities.

All current vacuum extraction systems have one major common problem—they are all limited by reach. The current truck mounted vacuum extraction systems must be parked near the excavation site because the suction hose is limited in length. Extensions can be added to the suction hose if the path to the excavation site is substantially flat with no high-rise obstacles (see FIG. 2). In other situations, structures of various heights, widths, and lengths, such as buildings, bridges, fences, and the like, block the path to the excavation site. Therefore, in some situations, truck mounted vacuum extraction systems cannot be used because the truck cannot get close enough to the excavation site or overcome barriers to reach the excavation site due to buildings or other objects and topographical conditions, such as draws, culverts, rivers, streams, trees, shrubs, and the like. Such objects/barriers/structures/topography are quite typical in oil fields, in cities, etc. Attempting to run extensions over such barriers/structures/topography would cause the suction hose to kink and collapse on itself, preventing the flow of debris and air through the extension hose. Thus, the ability to reach up, over, under, around, or through these existing objects is lacking. Moreover, in some applications, because of the limited reach, the truck has to be constantly moved to progress along the excavation site, which decreases efficiency. What is needed in the art is a truck mounted vacuum extraction system that overcomes the current limitations and inefficiencies.

### SUMMARY OF THE INVENTION

In one embodiment of the invention, a multi-segmented long boom, most commonly used in conjunction with a cement truck to deliver cement a great distance from the cement truck to the work site, is adapted to be used with a truck mounted vacuum extraction system. In this instance, the long boom is used in a completely backwards fashion. Instead of being connected to a pump that pumps cement or other materials to a work site, the long boom is connected to the vacuum extraction vacuum blower in order to bring debris at the excavation site to the debris tank of the vacuum extraction system. The long boom is able to reach over barriers that stand in the way. In addition, the long boom can also reach through or go under existing structures to reach the excavation site. The boom may also carry air hose and high-pressure water lines to accommodate different types of digging tools at the extraction site.

### BRIEF DESCRIPTION OF THE DRAWINGS

FIG. 1A shows a typical truck-mounted vacuum extraction system found in the prior art.

FIG. 1B shows a partial cross-section view of the truck-mounted vacuum extraction system shown in FIG. 1A.

FIG. 2 shows a series of extensions added to the suction hose of a truck-mounted vacuum extraction system as is known in the prior art.

FIG. 3 shows a side view of an embodiment of a long-reach vacuum extraction system of the present invention.

FIG. 4 shows a perspective view of a long-reach vacuum extraction system of FIG. 3 with the long boom extended.

FIG. 5 shows a view of the potential reach options of a long-reach vacuum extraction system of the present invention.

FIG. 6 shows a side view of another embodiment of a long-reach vacuum extraction system of the present invention.

FIG. 7 shows a side view of still another embodiment of a long-reach vacuum extraction system of the present invention.

FIG. 8 shows a side view of yet another embodiment of a long-reach vacuum extraction system of the present invention.

FIG. 9 shows a side view of yet another embodiment of a long-reach vacuum extraction system of the present invention.

To assist in the understanding of the present disclosure the following list of components and associated numbering found in the drawings is provided herein:

Table of Components

| Component | # |
|---|---|
| Suction Hose | 2 |
| Suction Hose | 2′ |
| Suction Hose | 2″ |
| Suction Hose | 2′″ |
| Short Boom | 4 |
| Stabilizer Jacks | 6 |
| Ground | 8 |
| Dig Tool | 9 |
| Debris | 10 |
| Debris Tank | 12 |
| Air Canal | 14 |
| Opening | 16 |
| Air Flow Arrows | 18 |
| Filter | 20 |
| Air Outlet | 22 |
| Vacuum Blower | 24 |
| Extensions | 26 |
| Excavation Site | 30 |
| Truck Chassis | 32 |
| Truck Chassis | 32′ |
| Truck Chassis | 32″ |
| Fuel Tank | 34 |
| Vacuum Extraction Unit | 35 |
| Vacuum Extraction Unit | 35′ |
| Vacuum Extraction Unit | 35″ |
| Vacuum Extraction Unit | 35′″ |
| Sub-Assembly | 36 |
| Sub-Assembly | 36′ |
| Sub-Assembly | 36″ |
| Sub-Assembly | 36′″ |
| Debris Tank | 38 |
| Debris Tank | 38′ |
| Debris Tank | 38″ |
| Debris Tank | 38′″ |
| Long Boom | 40 |
| Long Boom | 40′ |
| Long Boom | 40″ |
| Long Boom | 40′″ |
| Long Boom | 40″″ |
| Pedestrian Bridge | 42 |
| Water Line | 43 |
| Excavation Site | 44 |
| Air Line | 45 |
| Debris Trailer | 46 |
| Trailer Hitch | 47 |
| Long Boom Trailer | 48 |
| Connecting Hose | 50 |
| Connecting Hose | 52 |
| Transport Trailer | 54 |
| Vacuum Excavator | 100 |
| Sky-Vac | 300 |
| Sky-Vac | 300′ |
| Sky-Vac | 300″ |
| Sky-Vac | 300′″ |
| Sky-Vac | 300″″ |

### DETAILED DESCRIPTION

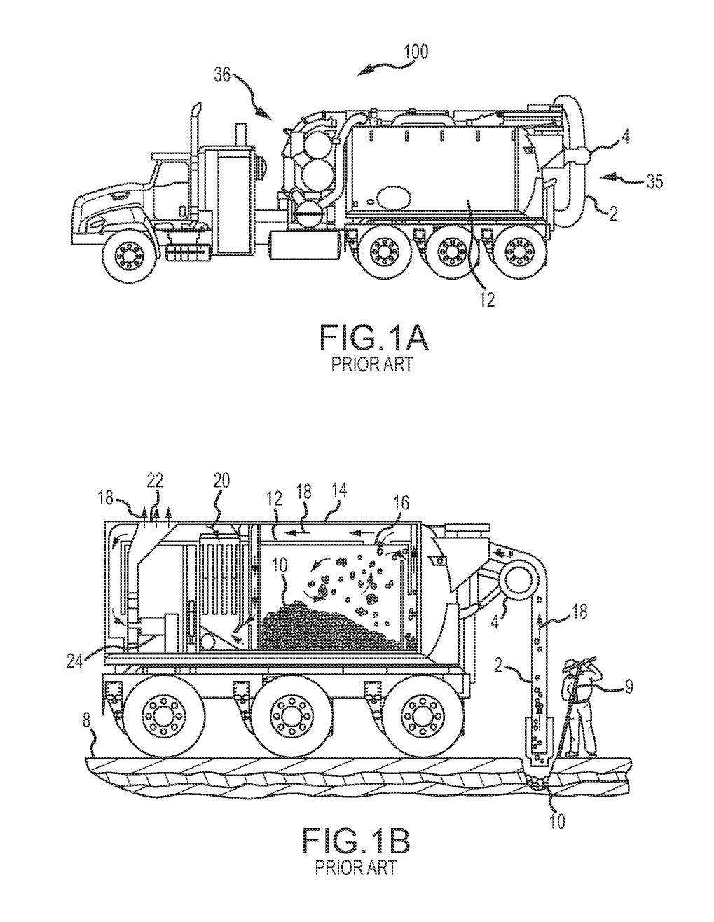

Referring now to the Figures, in which like reference numerals refer to structurally and/or functionally similar elements thereof, FIGS. 1A and 1B show an example of a truck-mounted vacuum extraction system as is known in the prior art. Referring now to FIGS. 1A and 1B, Vacuum Excavator 100, which may be a vacuum only excavation system or a hydro-excavation system, has Suction Hose 2 supported by Short Boom 4. Typically, Short Boom 4 is telescopic in design, extending straight out a short distance. Alternatively, Short Boom 4 may have one or more segments, each segment capable of being rotated between zero to ninety degrees. These types of booms are available with a reach of only between twenty to thirty feet at the time of this writing. Therefore, Vacuum Excavator 100 must be able to be driven fairly close to the excavation site. The Vacuum Extraction Unit 35 has a Sub-Assembly 36 that includes a fluid tank, a pump, and optionally a boiler (for a hydro-excavation system), intake/discharge silencers, a cooling silencer, the vacuum blower, and control boxes. Vacuum Excavator 100, if it is a hydro-excavation system, and based on a particular design, can typically carry anywhere between 1,500 to 2,500 gallons of fluid in the fluid tank. The pump can force fluid out of a handheld high-pressure fluid wand Dig Tool 9, typically between 2,000 to 3,000 pounds per square inch (PSI) at about twenty gallons per minute (GPM). Dig Tool 9 may also simply be a hand dig tool, such as a bar or shovel, a pneumatically driven air-powered handheld dig tool, or a high air-pressure handheld tool, such as an Air-Spade®. Dig Tool 9 breaks up Ground 8 and the resultant Debris 10 (soil, rocks, and/or fluid) is vacuumed up through Suction Hose 2, which is typically about eight inches in diameter, into Debris Tank 12. Debris Tank 12 may have a storage capacity of between eight to fifteen cubic yards (CU YD). Air Flow Arrows 18 indicate the direction of airflow through Vacuum Excavator 100. Air Canal 14 has an Opening 16 that allows the Debris 10 to drop into Debris Tank 12. Air flows through Filter 20 and exits through Air Outlet 22. Vacuum Blower 24, which creates the vacuum, may typically output anywhere between 4,000 to 6,500 standard cubic feet per minute (SCFM) of air. One skilled in the art will recognize that other values and parameters than those discussed above are possible based upon the design of a particular Vacuum Excavator 100. A significant disadvantage of Vacuum Excavator 100 is that vertical digging or potholing is limited to short distances.

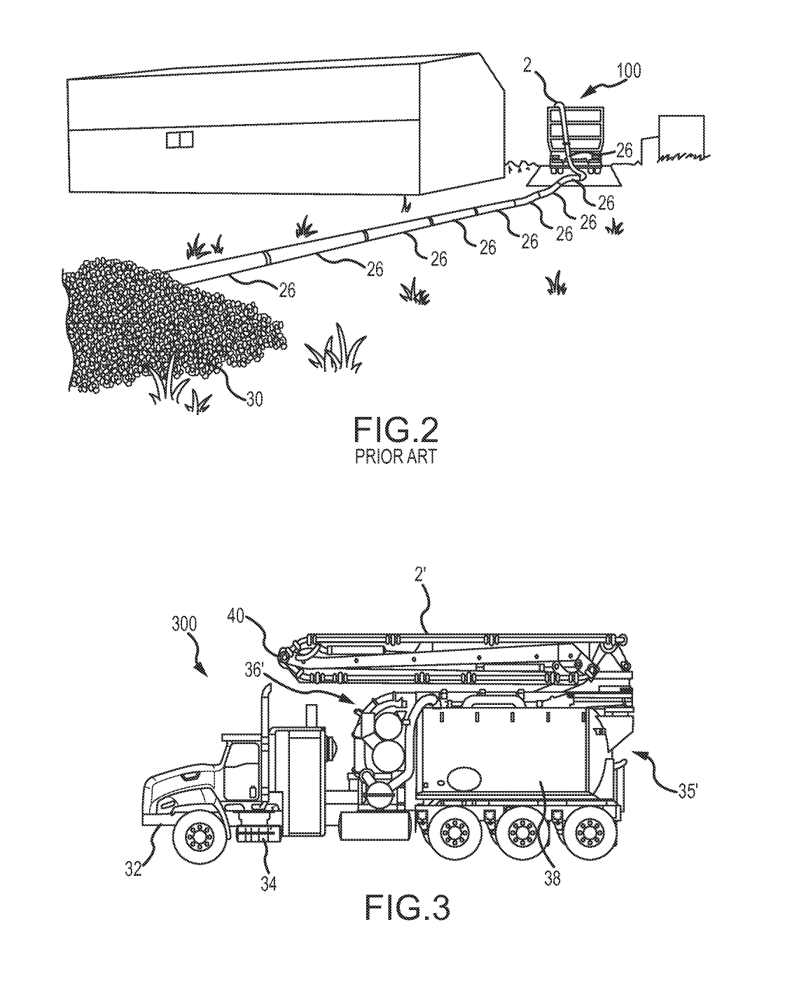

FIG. 2 shows a series of extensions added to the suction hose of a truck-mounted vacuum extraction system as is known in the prior art. Referring now to FIG. 2, Vacuum Excavator 100 cannot be parked directly near the above grade Excavation Site 30 so that Suction Hose 2 can be used directly. A series of Extensions 26 are connected together to extend the reach of Suction Hose 2 to Excavation Site 30. This works well if there are no height barriers, structures, or other hazards that cannot be traversed by Extensions 26. As shown in FIG. 2, the ground between Vacuum Excavator 100 and Excavation Site 30 is fairly flat and unobstructed, the ground providing the support that Extensions 26 need. Extensions 26 cannot be used unsupported, such as going up and over a wall or other structure, or to traverse a gap such as a trench or a gap between two walls or other structures. Without some sort of support, Extensions 26 will bounce, shake, and otherwise flop around when in use in a manner that may not be safe to any personnel standing next to Extensions 26. Unsupported Extensions 26 may require one or more personnel to restrain Extensions 26 while in use, which would be a waste of manpower and cost prohibitive. However, use of Extensions 26 will not work for potholing or other vertical digging because they are not supported.

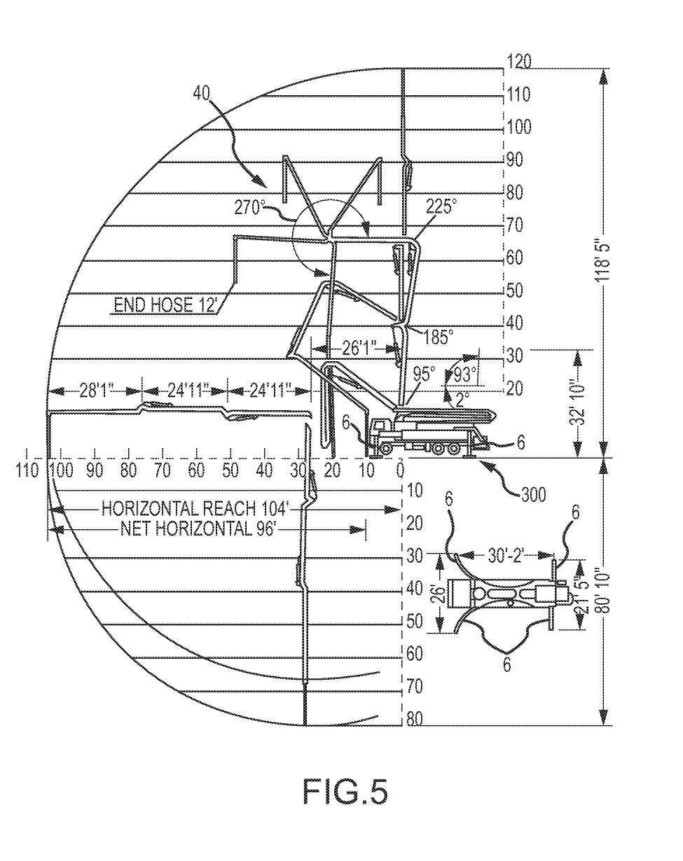

FIG. 3 shows a side view of an embodiment of a long-reach vacuum extraction system of the present invention. Referring now to FIG. 3, long-reach vacuum extraction system, referred to as Sky-Vac 300 is built upon a Truck Chassis 32, such as provided by CATERPILLAR® Inc., PETERBILT® Motors Company, KENWORTH® Truck Company, Mack® Trucks Inc., or any other suitable truck chassis manufacturer. Fuel Tank 34 provides fuel storage for Sky-Vac 300. The Vacuum Extraction Unit 35′ has a Sub-Assembly 36′ that includes a fluid tank, a pump, and optionally a boiler (for a hydro-excavation system), intake/discharge silencers, a cooling silencer, the vacuum blower, and control boxes. The fluid tank stores the fluid pumped by the pump under pressure and delivered through a handheld dig tool to loosen the soil at an excavation site. The discharge silencer vents the air from the tank and out of the system and dampens the sound. The cooling silencer cools the air introduced into the vacuum blower to keep the temperature down. The vacuum blower provides the powerful vacuum to extract the debris, which is collected in Debris Tank 38. With the aid of the boiler, the fluid is heated for conditions requiring digging in cold or frozen ground. The control boxes provide the operator with all of the controls necessary to operate Sky-Vac 300. Long Boom 40 (shown in the folded position) provides support for Suction Hose 2′ and is extended to reach an excavation site located at a great distance from Sky-Vac 300. A portion of Suction Hose 2′ extends from the end of Long Boom 40 and may be moved by hand by an operator at the excavation site. Long Boom 40 may be one of several types available from Schwing® America Inc., Putzmeister® America, Inc., Reed Manufacturing Company, or any other suitable boom manufacturer. Long Boom 40 is available in different sizes and designs (e.g., 3-section roll and fold; 4-section double z; 5-section telescoping boom; 4-section roll and fold; 5-section roll and fold; 4-section overhead roll and fold; and 5-section overhead roll and fold to name a few). Based upon the size and design, Long Boom 40 may reach between 50 to 160 feet at the time of this writing. Thus, Sky-Vac 300, can be configured to be capable of reaching between two-times and up to eight-times as far as a typical Vacuum Excavator 100 and be fully supported by Long Boom 40 over that distance. A transfer case (not visible in FIG. 3) in Truck Chassis 32 connects the transmission to the drive shaft and a second driveline connects to the vacuum blower. Sky-Vac 300 may be equipped with stabilizer Jacks 6 as shown in FIG. 5.

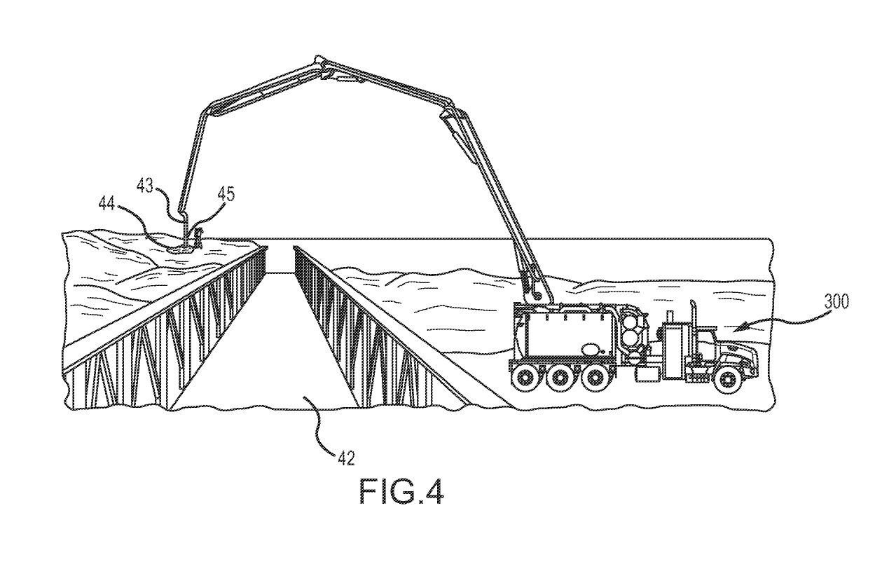

FIG. 4 shows a perspective view of a long-reach vacuum extraction system of FIG. 3 with the boom extended. Referring now to FIG. 4, Long Boom 40 of Sky-Vac 300 extends over a Pedestrian Bridge 42 in order to reach Excavation Site 44. Laying Extensions 26 on the ground, up and over the rails of the Pedestrian Bridge 42 and on to the Excavation Site 44 is not practical or safe, or even possible, in this situation. In addition, potholing or vertical drilling would be impossible using Extensions 26.

In another embodiment, a Water Line 43 and an Air Line 45 are run along the length of the boom and flexed at each of the joints to allow for the bending required. A water-powered or air-powered Dig Tool 9 connected at or secured near to the end of Suction Hose 2′ assists in helping to break up and suction material. Through the use of water-powered or air-powered Dig Tools 9, debris can be broken up and directed toward the end of Suction Hose 2′. The water pressure at the end of Water Line 43 may only need to be low pressure, around twenty to thirty PSI, or it could be a high-pressure line depending upon the application. Water, steam, oil, surfactants, or any other suitable fluids may be utilized for the Water Line 43 depending on the application. Compressed air, nitrogen, carbon dioxide, or any other suitable gas may be utilized for Air Line 45 depending upon the application. Having gas or fluid available at the end of Long Boom 40 gives the operators many options for effectively excavating a variety of materials.

FIG. 5 shows a view of the potential reach options of a long-reach vacuum extraction system of the present invention. Referring now to FIG. 5, various scenarios are shown regarding the flexibility of reach of Long Boom 40 of Sky-Vac 300. Excavations can be made straight down for potholing immediately next to Sky-Vac 300, horizontally in any direction, and most importantly, for going up, over, under, or around barriers of various shapes or through openings in existing structures. Thus, Long Boom 40 of Sky-Vac 300 enables extraction ranging from immediately proximal to Sky-Vac 300, at great distances away from Sky-Vac 300, and anywhere in-between, and also allows for potholing or vertical digging along the way.

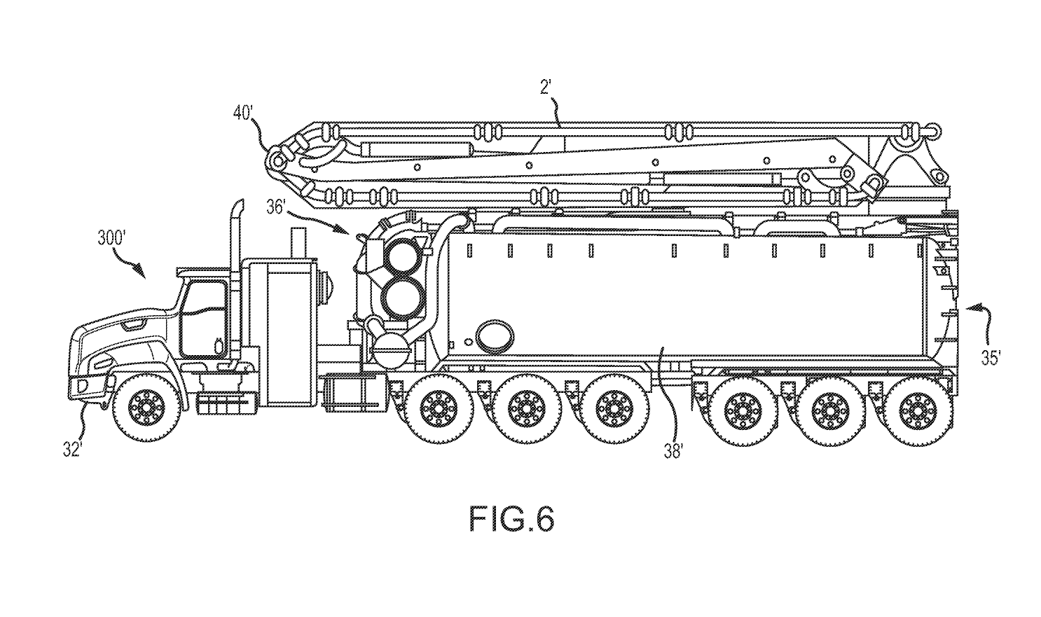

FIG. 6 shows a side view of another embodiment of a long-reach vacuum extraction system of the present invention. Referring now to FIG. 6, in this embodiment, Sky-Vac 300′ has Vacuum Extraction Unit 35′ with a Sub-Assembly 36′, a larger Debris Tank 38′ on an extended Truck Chassis 32′. Long Boom 40′ is also larger, extending the reach of Sky-Vac 300′.

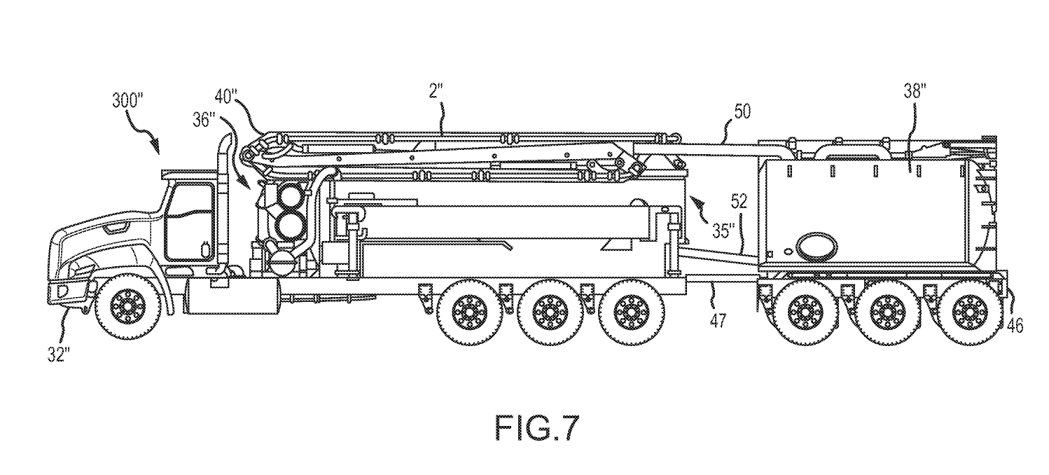

FIG. 7 shows a side view of another embodiment of a long-reach vacuum extraction system of the present invention. Referring now to FIG. 7, Sky-Vac 300″ has Truck Chassis 32″, Vacuum Extraction Unit 35″, Sub-Assembly 36″, and Long Boom 40″ and is capable of pulling a Debris Trailer 46 when coupled together, such as with a Trailer Hitch 47. Debris Trailer 46 has a Debris Tank 38″. Connecting Hose 50 connects suction hose 2′ to Debris Tank 38″. Connecting Hose 50 may include any combination of reducers or adapters to make the connection to a flange at suction hose 2″ and a flange at Debris Tank 38″. Vacuum Connecting Hose 52 connects Debris Tank 38″ to the vacuum blower flange on Sky-Vac 300″ and may include any combination of reducers or adapters to make the connections. Debris Trailer 46 is uncoupled from Sky-Vac 300″ when the Debris Tank 38″ needs to be dumped. A second Debris Trailer 46 is coupled to Sky-Vac 300″ in place of the first Debris Trailer 46. The first Debris Trailer 46 can then be hauled away to dump the Debris 10. In this manner, Sky-Vac 300″ can stay actively engaged with the excavation site while multiple Debris Trailers 46 are ferried to and from the excavation site and the dumpsite.

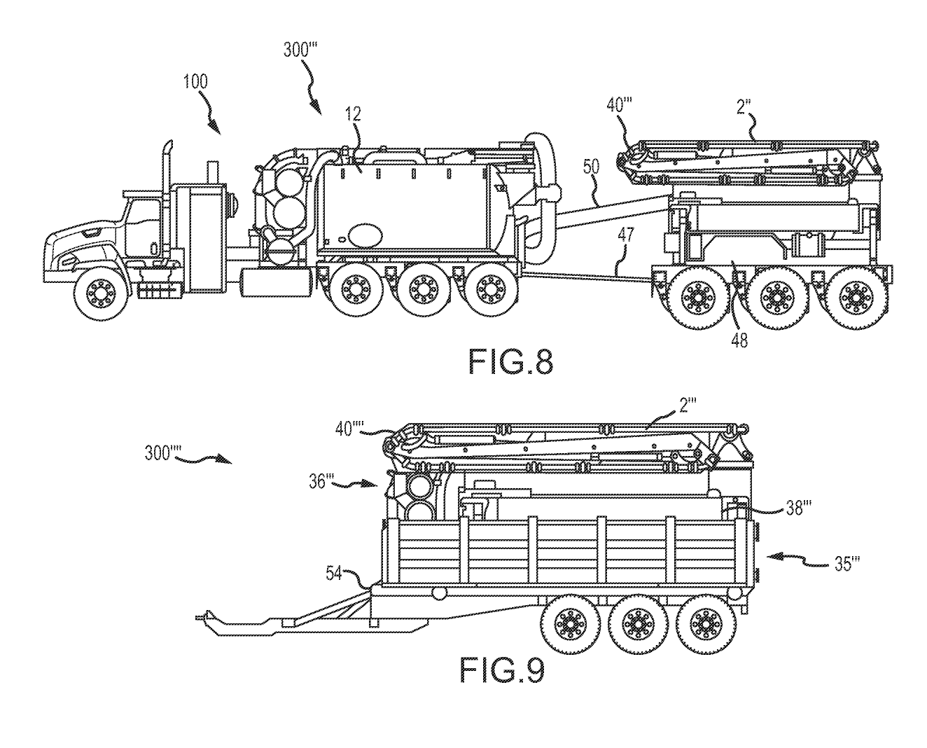

FIG. 8 shows a side view of still another embodiment of a long-reach vacuum extraction system of the present invention. Referring now to FIG. 8, Sky-Vac 300′″ has Vacuum Excavator 100 as known in the prior art (see FIGS. 1A and 1B) that pulls Long Boom 40″ mounted on a Long Boom Trailer 48 having a Trailer Hitch 47. In this manner, Long Boom Trailer 48 is set up proximate to the excavation site and connected to Vacuum Excavator 100. Long Boom 40′″ is extended so that the end of Long Boom 40′″ reaches the excavation site. Connecting Hose 50 connects suction hose 2″ to Debris Tank 12 located on Vacuum Excavator 100. When Debris Tank 12 is full, Vacuum Excavator 100 is uncoupled from Long Boom Trailer 48, and driven to the dumpsite. A second Vacuum Excavator 100 (not shown) can be coupled to Long Boom 40′″ on Long Boom Trailer 48. In this manner, Long Boom 40′″ on Long Boom Trailer 48 can stay actively engaged with the excavation site while multiple Vacuum Excavators 100 are ferried to and from the excavation site and the dumpsite.

In another embodiment, Long Boom 40′″ is transported by Long Boom Trailer 48 to a location proximate to an excavation site, and lifted off Long Boom Trailer 48 and set on the ground for the duration of the extraction project. Long Boom 40′″ is once again connected to one or more Vacuum Excavators 100 and Long Boom 40′″ is extended so that the end of Long Boom 40′″ reaches the excavation site. Once the extraction project is over, Long Boom Trailer 48 is returned to the excavation site and Long Boom 40′″ is uncoupled from Vacuum Excavator 100 and lifted off the ground, placed on Long Boom Trailer 48, and transported to the next excavation site.

FIG. 9 shows a side view of still another embodiment of a long-reach vacuum extraction system of the present invention. In this embodiment, Sky-Vac 300″″ is not built upon a Truck Chassis 32, but is a standalone unit that is transported to and from the excavation site and lifted off a Transport Trailer 54 at the beginning of an extraction process and lifted back on to a Transport Trailer 54 at the end of an extraction process. Sky-Vac 300″″ has Vacuum Extraction Unit 35″+ that has Sub-Assembly 36″′, Debris Tank 38″′, and Long Boom 40″″. Long Boom 40″″ (shown in the folded position) provides support for Suction Hose 2′″ and is extended to reach an excavation site located at a great distance from Sky-Vac 300″″. Sub-Assembly 36″′ includes a fluid tank, a pump, and optionally a boiler (for a hydro-excavation system), and a discharge silencer, a cooling silencer, the vacuum blower, and control boxes. The fluid tank stores the fluid pumped by the pump under pressure and delivered through a handheld dig tool to loosen the soil at an excavation site. The discharge silencer vents the air from the tank and out of the system and dampens the sound. The cooling silencer cools the air introduced into the vacuum blower to keep the temperature down. This standalone unit may also be lifted onto a barge or other water vessel for transport to an excavation site. Alternatively, Sky-Vac 300″″ could be driven onto a barge, unhitched from the transport vehicle, and transported to an excavation site where it remains on the barge during the extraction process.

Having described the present invention, it will be understood by those skilled in the art that many changes in construction and widely differing embodiments and applications of the invention will suggest themselves without departing from the scope of the present invention.

What is claimed is:

1. An apparatus for long-reach vacuum extraction comprising:
a truck chassis;
a vacuum extraction unit mounted to the truck chassis, the vacuum extraction unit having a vacuum blower;
a debris tank having an airflow connection to the vacuum blower;
a long boom mounted to the vacuum extraction unit, wherein the long boom is extendible to reach up, over, under, around, or through existing objects to gain access to an excavation site; and
a suction hose having a first end extending from a distal end of the long boom, running through the length of the long boom, and connected at a second end to the debris tank.

2. The apparatus for long-reach vacuum extraction according to claim 1 wherein a debris at the excavation site is transported by the vacuum blower through the suction hose and into the debris tank.

3. The apparatus for long-reach vacuum extraction according to claim 1 wherein the vacuum extraction unit further comprises:
a discharge silencer that vents air from the debris tank and dampens sound; and
a cooling silencer that cools the air introduced into the vacuum blower to keep a temperature down.

4. The apparatus for long-reach vacuum extraction according to claim 1 further comprising:
at least one handheld dig tool selected from the group consisting of a bar, a shovel, a high-pressure fluid wand, a pneumatically driven air-powered dig tool, and a high air-pressure dig tool to loosen the debris at the excavation site.

5. The apparatus for long-reach vacuum extraction according to claim 4 wherein the vacuum extraction unit further comprises:
a fluid tank; and
a pump;
wherein the fluid tank stores a fluid that is pumped by the pump under pressure and delivered through the high-pressure fluid wand to loosen the debris at the excavation site.

6. The apparatus for long-reach vacuum extraction according to claim 5 wherein the vacuum extraction unit further comprises:
a boiler;
wherein the fluid can be heated by the boiler and supplied to the high-pressure fluid wand for conditions when the excavation site is cold or frozen.

7. An apparatus for long-reach vacuum extraction comprising:
a truck chassis:
a vacuum extraction unit mounted to the truck chassis, the vacuum extraction unit having a vacuum blower;
a long boom mounted to the vacuum extraction unit, wherein the long boom is extendible to reach up, over, under, around, or through existing objects to gain access to an excavation site;
a first debris trailer coupled to the truck chassis, the first debris trailer having a first debris tank; and
a suction hose having a first end extending from a distal end of the long boom, running through the length of the long boom, and connected at a second end to the first debris tank.

8. The apparatus for long-reach vacuum extraction according to claim 7 wherein debris at the excavation site is transported by the vacuum blower through the suction hose and into the first debris tank.

9. The apparatus for long-reach vacuum extraction according to claim 7 further comprising:
a second debris trailer having a second debris tank;
wherein the first debris trailer is uncoupled from the truck chassis and the second end of the suction hose is disconnected from the first debris tank, and the second debris trailer is coupled to the truck chassis and the second end of the suction hose is connected to the second debris tank so that the apparatus can stay actively engaged with the excavation site.

10. The apparatus for long-reach vacuum extraction according to claim 7 further comprising:
a first connecting hose connecting the second end of the suction hose to the first debris tank; and
a second connecting hose connecting the first debris tank to the vacuum blower.

11. An apparatus for long-reach vacuum extraction comprising:
a first vacuum excavator having a first debris tank;
a long boom mounted on a long boom trailer, wherein the long boom trailer is coupled to the first vacuum excavator and the long boom is extendible to reach up, over, under, around, or through existing objects to gain access to an excavation site; and
a suction hose having a first end extending from a distal end of the long boom, running through the length of the long boom, and connected at a second end to the first debris tank.

12. The apparatus for long-reach vacuum extraction according to claim 11 wherein debris at the excavation site is transported by a vacuum blower located in the first vacuum excavator through the suction hose and into the first debris tank.

13. The apparatus for long-reach vacuum extraction according to claim 11 further comprising:
a second vacuum excavator having a second debris tank;
wherein the first vacuum excavator is uncoupled from the long boom trailer and the second end of the suction hose is disconnected from the first debris tank, and the second vacuum excavator is coupled to the long boom trailer and the second end of the suction hose is connected to the second debris tank so that the apparatus can stay actively engaged with the excavation site.

14. The apparatus for long-reach vacuum extraction according to claim 11 further comprising:
a connecting hose connecting the second end of the suction hose to the first debris tank.

15. The apparatus for long-reach vacuum extraction according to claim 11 wherein the long boom is removed from the long boom trailer and positioned on the ground proximate to the excavation site before coupling the long boom to the vacuum excavator, and after extraction of the debris is completed, the long boom is uncoupled from the vacuum excavator and placed back onto the long boom trailer and transported to a next excavation site.

16. An apparatus for long-reach vacuum extraction comprising:
a transport trailer;
a vacuum extraction unit positioned in the transport trailer, the vacuum extraction unit having a vacuum blower;
a debris tank having an air flow connection to the vacuum blower;
a long boom mounted to the vacuum extraction unit, wherein the long boom is extendible to reach up, over, under, around, or through existing objects to gain access to an excavation site; and
a suction hose having a first end extending from a distal end of the long boom, running through the length of the long boom, and connected at a second end to the debris tank.

17. The apparatus for long-reach vacuum extraction according to claim 16 wherein a debris at the excavation site is transported by the vacuum blower through the suction hose and into the debris tank.

18. The apparatus for long-reach vacuum extraction according to claim 16 further comprising:
at least one handheld dig tool selected from the group consisting of a bar, a shovel, a high-pressure fluid wand, a pneumatically driven air-powered dig tool, and a high air-pressure dig tool to loosen the debris at the excavation site.

19. The apparatus for long-reach vacuum extraction according to claim 18 wherein the vacuum extraction unit further comprises:
a fluid tank; and
a pump;
wherein the fluid tank stores a fluid that is pumped by the pump under pressure and delivered through the high-pressure fluid wand to loosen the debris at the excavation site.

20. The apparatus for long-reach vacuum extraction according to claim 19 wherein the vacuum extraction unit further comprises:
a boiler;
wherein the fluid can be heated by the boiler and supplied to the high-pressure fluid wand for conditions when the excavation site is cold or frozen.

21. A method for long-reach vacuum extraction, the method comprising the steps of:
(a) extending a long boom to reach up, over, under, around, or through existing objects to gain access to an excavation site, the long boom being mounted to a vacuum extraction unit having a vacuum blower connected to a debris tank, the vacuum extraction unit being mounted to a truck chassis, the long boom having a suction hose running through the length of the long boom and a proximal end of the suction hose is connected to the debris tank; and
(b) transporting a debris from the excavation site with the vacuum blower through the suction hose and into the debris tank.

22. The method for long-reach vacuum extraction according to claim 21 further comprising the steps of:
venting air from the debris tank through a discharge silencer that dampens sound; and
cooling air introduced into the vacuum blower with a cooling silencer to keep a temperature down.

23. The method for long-reach vacuum extraction according to claim 21 further comprising the step of:
loosening the debris at the excavation site with at least one handheld dig tool selected from the group consisting of a bar, a shovel, a high-pressure fluid wand, a pneumatically driven air-powered dig tool, and a high air-pressure dig tool.

24. The method for long-reach vacuum extraction according to claim 23 further comprising the steps of:
storing a fluid in a fluid tank; and
pumping the fluid under pressure to the high-pressure fluid wand to loosen the debris at the excavation site.

25. The method for long-reach vacuum extraction according to claim 24 further comprising the step of:
heating the fluid with a boiler before pumping the fluid to the high-pressure fluid wand when the excavation site is cold or frozen.

26. The method for long-reach vacuum extraction according to claim 21 further comprising the step of:
driving the truck chassis to a position near the excavation site.

27. A method for long-reach vacuum extraction, the method comprising the steps of:
(a) coupling a first debris trailer having a first debris tank to a truck chassis;
(b) extending a long boom to reach up, over, under, around, or through existing objects to gain access to an excavation site, the long boom being mounted to a vacuum extraction unit having a vacuum blower, the vacuum extraction unit being mounted to the truck chassis, the long boom having a suction hose running through the length of the long boom and a proximal end of the suction hose is connected to the first debris tank; and
(c) transporting a debris from the excavation site with the vacuum blower through the suction hose and into the first debris tank.

28. The method for long-reach vacuum extraction according to claim 27 further comprising the steps of:
uncoupling the first debris trailer from the truck chassis;
disconnecting the proximal end of the suction hose from the first debris tank;
coupling a second debris trailer having a second debris tank to the truck chassis; and
connecting the proximal end of the suction hose to the second debris tank;
wherein the apparatus can stay actively engaged with the excavation site.

29. The method for long-reach vacuum extraction according to claim 27 further comprising the steps of:
connecting a connecting hose to the proximal end of the suction hose and to the first debris tank; and
connecting a second connecting hose to the first debris tank and to the vacuum blower.

30. A method for long-reach vacuum extraction, the method comprising the steps of:
(a) coupling a long boom trailer having a long boom mounted thereon to a first vacuum excavator, the long boom having a suction hose running through the length of the long boom and a proximal end of the suction hose is connected to a first debris tank in the first vacuum excavator;
(b) extending the long boom to reach up, over, under, around, or through existing objects to gain access to an excavation site; and
(c) transporting a debris from the excavation site with a vacuum blower located in the first vacuum excavator through the suction hose and into the first debris tank.

31. The method for long-reach vacuum extraction according to claim 30 further comprising the steps of:
uncoupling the first vacuum excavator from the long boom trailer;
disconnecting the proximal end of the suction hose from the first debris tank;
coupling a second vacuum excavator having a second debris tank to the long boom trailer; and
connecting the proximal end of the suction hose to the second debris tank;
wherein the apparatus can stay actively engaged with the excavation site.

32. The method for long-reach vacuum extraction according to claim 30 further comprising the step of:
connecting a connecting hose to the proximal end of the suction hose and to the first debris tank.

33. The method for long-reach vacuum extraction according to claim 30 further comprising the steps of:
removing the long boom from the long boom trailer;
positioning the long boom on the ground proximate to the excavation site before coupling the long boom to the vacuum excavator;
after extraction of the debris is completed, uncoupling the long boom from the vacuum excavator; and
placing the long boom back onto the long boom trailer for transportation to a next excavation site.

34. A method for long-reach vacuum extraction, the method comprising the steps of:
(a) pulling a transport trailer containing a long-reach vacuum extraction system to an excavation site;
(b) lifting the long-reach vacuum extraction system from the transport trailer and placing the long-reach vacuum extraction system on the ground near the excavation site;
(c) extending a long boom to reach up, over, under, around, or through existing objects to gain access to an excavation site, the long boom being mounted to a vacuum extraction unit having a vacuum blower connected to a debris tank, the long boom having a suction hose running through the length of the long boom and a proximal end of the suction hose is connected to the debris tank; and
(d) transporting a debris from the excavation site with the vacuum blower through the suction hose and into the debris tank.

35. The method for long-reach vacuum extraction according to claim 34 further comprising the step of:
loosening the debris at the excavation site with at least one handheld dig tool selected from the group consisting of a bar, a shovel, a high-pressure fluid wand, a pneumatically driven air-powered dig tool, and a high air-pressure dig tool.

36. The method for long-reach vacuum extraction according to claim 34 further comprising the steps of:
when transporting the debris from the excavation site is complete, lifting the long-reach vacuum extraction system from the ground placing the long-reach vacuum extraction system on the transport trailer; and
pulling the transport trailer containing the long-reach vacuum extraction system to a next excavation site.

37. The method for long-reach vacuum extraction according to claim 34 further comprising the step of:
lifting the long-reach vacuum extraction system from the ground and placing the long-reach vacuum extraction system on a barge or other water vessel for transport to a next excavation site.

38. The method for long-reach vacuum extraction according to claim 34 further comprising the step of:
pulling the transport trailer containing the long-reach vacuum extraction system to a barge or other water vessel for transport to a next excavation site.
